(19) United States
(12) Patent Application Publication
(10) Pub. No.: US 2011/0086975 A1
(43) Pub. Date: Apr. 14, 2011

(54) COLORED GEL COAT COMPOSITION AND ARTICLE

(76) Inventors: Thomas Melnyk, Greenfield, MN (US); Brian A. Robertson, The Colony, TX (US)

(21) Appl. No.: 12/900,726

(22) Filed: Oct. 8, 2010

Related U.S. Application Data
(60) Provisional application No. 61/250,226, filed on Oct. 9, 2009.

(51) Int. Cl. C08L 67/06

(52) U.S. Cl. 524/604

(57) ABSTRACT

Gel coat compositions and/or components thereof that have low viscosity characteristics while also incorporating relatively high molecular weight resin material. In representative embodiments, this is achieved by using a curable polyester resin with low polydispersity in the gel coat compositions and/or one or more components thereof. In preferred embodiments, such resin material is used to prepare one or more color components that can be readily blended with one or more other gel coat resin components to form gel coat compositions. These compositions can be cured to form gel coats. By blending the components according to recipes, a wide range of different gel coat compositions with custom color or other visual appearance can be prepared on demand from a limited inventory of color components.

### PRIORITY

The present non-provisional patent Application claims benefit from U.S. Provisional Patent Application having Ser. No. 61/250,226, filed on Oct. 9, 2009, by Thomas Melnyk, and titled COLORED GEL COAT COMPOSITION AND ARTICLE, wherein the entirety of said provisional patent application is incorporated herein by reference.

### FIELD OF THE INVENTION

The present invention relates to colored gel coat compositions and articles employing colored gel coat compositions.

### BACKGROUND

A gel coat generally refers to a coating that is used to provide a high quality finish on the visible surface of a substrate. Gel coats also impart weather resistance, wear resistance, protection against moisture; and cosmetic benefits. For instance, gel coats can provide surfaces with high initial and extended gloss for long-lasting visual appeal. Gel coats can also be used to present desired color characteristics or other visual effects such as fluorescent, pearlescent, iridescent, metallic reflective, non-reflective, and/or retroreflective effects, or the like. Gel coats are used on a wide variety substrates, including surfaces of marine vessels, motor vehicles, air craft, recreational vehicles, pools, counter tops, appliances, bathroom fixtures, buildings and other man-made structures, sports equipment, and the like,

The substrates supporting gel coats can be made from a wide range of materials. Representative substrate materials include paper; cardboard; wood or other natural or man-made cellulosic products; woven or nonwoven textiles; crystalline or amorphous metallic materials (including metals, metal alloys, intermetallic compositions, and the like); thermoplastic and/or thermoset polymers or composites incorporating such polymers optionally reinforced with materials such as fiberglass mat or cloth, fibers, etc.;

ceramic materials; cementitious materials; biomaterials; other composites; combinations of these; and the like.

A typical gel coat often is derived from a curable composition including at least one or more curable resins and one or more optional, additional ingredients. The composition in fluid form is applied onto a supporting surface and cured to form a solid coating. In some cases, the supporting surface is the substrate to be coated. In some other instances, the supporting surface may be the surface of a mold that corresponds to the negative relief of the desired article. The substrate can then be constructed in situ against the gel coat material (which often is at least partially cured or fully cured at this stage), or the substrate can be pre-formed.

It is desirable to provide gel coat compositions that provide many options for color and/or other visual effects. It can be challenging, though, to prepare pigmented gel coat compositions that have low enough viscosity characteristics to be compatible with desired manufacturing techniques. In particular, viscosity of the compositions tends to increase with increasing pigment content. At some desired pigment loadings, viscosity may tend to be too high. Accordingly, formulation strategies that allow colored, UV resistant, heat resistant, hydrolytically stable gel coat compositions to be formed at suitably low viscosity are needed.

Even though a formulation needs to have a sufficiently low viscosity to be suitable, the curable resin components must also have relatively high molecular weight in order to provide desired performance characteristics. For instance, higher molecular weight resins tend to provide resultant coatings that are more resistant to moisture, more durable, and/or the like. However, viscosity tends to increase rapidly with increasing molecular weight. Consequently, providing formulations with higher molecular weight resins often conies at the expense of viscosity characteristics, and vice versa.

It also would be desirable to provide a system that allows a wide range of gel coat compositions with custom color or other visual properties to be blended on demand from a more limited inventory of base compositions and/or color components. For instance, such a system might include one or more base color components and one or more color components. These components can be blended according to particular recipes to provide a resultant gel coat composition with the desired visual appearance. However, viscosity concerns make it difficult to provide such a system in actual practice. If the viscosity of the components is too high, blending may be too difficult to be technically or economically feasible. This is another reason why formulation strategies with low viscosity characteristics are desirable.

### SUMMARY

The present invention provides gel coat compositions and/or components thereof that have low viscosity characteristics while also incorporating relatively high molecular weight resin material. In representative embodiments, this is achieved by using a curable polyester resin with low polydispersity in the gel coat compositions and/or one or more components thereof. In preferred embodiments, such resin material is used to prepare one or more color components that can be readily blended with one or more other gel coat resin components to form gel coat compositions. These compositions can be cured to form gel coats. By blending the components according to recipes, a wide range of different gel coat compositions with custom color or other visual appearance can be prepared on demand from a limited inventory of color components.

In one aspect, the present invention relates to a system for providing a colored, curable coating composition on demand, comprising a first color component comprising a curable resin and providing a first color; a second color component providing a second color, wherein at least one of the first and second color components comprises a curable polyester resin having a polydispersity of less than about 3: and a recipe for combining ingredients including at least one of the first and second color components to provide a curable coating composition having a desired color characteristic.

In another aspect, the present invention relates to a system for providing a colored coating composition on demand, comprising a plurality of color components, each component having a visually discernible appearance characteristic and each color component comprising a curable polyester resin having a polydispersity of less than about 3; at least one additional component comprising a curable resin; and a plurality of recipes, each recipe providing information to combine ingredients comprising at least one color component and at least one additional component to provide a curable coating composition having a desired visual appearance characteristic.

In another aspect, the present invention relates to a colored component of a gel coat composition comprising a colorant component comprising a colorant and a curable polyester resin carrier, the curable polyester resin carrier having a polydispersity of less than about 3; and a gel coat resin component comprising a curable resin.

In another aspect, the present invention relates to a method of making a colored curable coating composition on demand, comprising the steps of providing a system according to any aspect herein; and using a recipe to blend at least one color component with ingredients comprising at least one other system component to provide the colored, curable, coating composition.

In another aspect, the present invention relates to a method of making a colored curable coating composition on demand, comprising the steps of providing a system according to any aspect described herein; and using a recipe to blend at least one color component with ingredients comprising at least one additional component to provide the colored, curable, coating composition.

In another aspect, the present invention relates to a composite panel, comprising a coating provided on a substrate, said coating being derived from a curable coating composition comprising a colorant and a curable polyester resin having a polydispersity of less than about 3.

### BRIEF DESCRIPTION OF THE DRAWING

The above-mentioned and other advantages of the present invention, and the manner of attaining them, will become more apparent and the invention itself will be better understood by reference to the following description of the embodiments of the invention taken in conjunction with the accompanying drawings, wherein:

FIG. 1 is a schematic cross-section representation of a multi-layer (e.g., two-layer) composite made from one embodiment of a colored, curable gel coating composition of the invention provided and cured on a supporting surface of a substrate.

### DETAILED DESCRIPTION

The embodiments of the present invention described below are not intended to be exhaustive or to limit the invention to the precise forms disclosed in the following detailed description. Rather the embodiments are chosen and described so that others skilled in the art may appreciate and understand the principles and practices of the present invention.

Curable gel coat compositions of the invention are obtained by combining ingredients comprising at least one curable colorant component with at least one curable gel resin component. The compositions are cured to form gel coats. The resultant gel coats can be formed on substrates in a variety of ways. For instance, a curable gel coat composition can be applied onto a substrate and then cured. In other approaches, a gel coat composition can be applied onto the surface of a female mold. Then, the substrate can be developed against the gel coat material. The gel coat composition can be cured before and/or after substrate development.

The colorant component employed in the present invention helps to provide the resultant cured gel coat with desired color characteristics. In some instances, two or more colorant components having respective color characteristics can be used in combination to provide the desired gel coat color. In this way, an inventory of a relatively limited number of colorant components can be kept on hand, and one or more of these can be blended together according to color recipes to provide a much wider range of colors on demand. Similarly, an inventory of one or more gel resin components (described below) may be kept in the inventory. If such gel resin components include color characteristics, the gel resin components may be used as base color(s) to be used in combination with the colorant component(s) to provide mixed colors on demand according to such color recipes.

The color of the uncured gel coat composition may differ to some degree from the color of the cured gel coat. A similar effect is often seen with house paint. House paint tends to darken to some degree upon drying in many instances. Accordingly, it may be desirable to prepare and cure a sample of the candidate gel coat composition from the corresponding colorant and gel resin components to see if the resultant color matches the desired color to a satisfactory degree. The color mixing recipes may take this effect into account, and the color model used to develop the recipes may be built upon empirical studies.

A colorant component of the present invention is derived from ingredients that generally include at least one colorant in admixture with a curable, polyester carrier resin. The curable polyester carrier resin generally may constitute from about 55 to about 95, preferably 75 to about 90, weight percent of the colorant component. The colorant component usually includes from about 5 to about 45, preferably 10 to about 20 parts by weight of colorant per about 100 parts by weight of the curable polyester carrier resin.

The curable polyester carrier resin has low polydispersity characteristics that promote low viscosity with relatively high number average molecular weight. For instance, colorant compositions of the present invention may be prepared having a number average molecular weight (Mn) in the range from about 700 to about 15,000, preferably about 800 to about 5000, more preferably about 900 to about 3000. The colorant compositions may have a viscosity in the range from about 50 KU to about 140 KU, preferably 60 KU to about 130 KU, more preferably about 90 KU to about 120 KU measured at 77 F. As used herein, viscosity refers to the Krebs viscosity and is determined according to ASTMD562.

As used herein, the term “polyester” means that the carrier resin generally includes a plurality (e.g., at least two) of ester linkages in the backbone of the resin. Optionally, other kinds of backbone linkages may also be present, including by way of example, urethane, amide, imide; urea, carbonate, epoxy, ether, combinations of these, and the like.

Advantageously, the curable polyester carrier resin has a narrow molecular weight distribution characterized by a polydispersity of less than about 3, preferably less than about 2.5, more preferably less than about 2.2, and even more preferably less than about 2.0. One embodiment of a curable polyester carrier resin would have a polydispersity of about 1.8.

As used herein, polydispersity refers to the molecular weight polydispersity that is given by the ratio of the weight average molecular weight (Mw) to the number average molecular weight (Mn) (i.e., Mw/Mn). Molecular weight parameters may be determined using any suitable procedures. According to one approach, molecular weight features can be determined via gel permeation chromatography (GPC). Suitable GPC equipment and software includes Waters Millenium version 4.0 chromatography software, Waters 515 pump, Waters 717plus auto-injector, Waters 2410 refractive index detector, Jordi-Gel DVB 1000 angstrom 250 mm column #15022, and Jordi-Gel DVB 10000 angstrom 500 mm column #15003. Tetrahydrofuran (THF) containing 290 mg/L of butylated hydroxyl toluene (BHT) as a preservative is used as a solvent. Solvent flow during analysis is 1 ml/minute. Chlorobenzene also is used. Low polydispersity standards are used to calibrate the GPC system. The standards and corresponding number average molecular weights are as follows:

### Molecular Weight (Mn):

| Standard A: | Standard B: |
|---|---|
| 7,500,000 | 2,560,000 |
| 841,700 | 320,000 |
| 148,000 | 59,500 |
| 28,500 | 9,920 |
| 2930 | 580 |
| 110 (chlorobenzene, | 110 (chlorobenzene, |
| internal standard) | internal standard) |

To carry out GPC analysis, samples are prepared at a concentration of approximately 2% resin solids in THF/0.005 gram/mL chlorobenzene. Total weight should be approximately 10 grams. The samples are filtered into an autosampler vial through a Teflon filter attached to a 3 ml. syringe. Desirably, pigmented samples are centrifuged prior to filtration. Samples desirably are not sonicated. The apparatus is checked to see that the flow rate is 1 ml./min. The setup function is pressed on the “GPC instrument method”. The sample set includes a 10 min injector purge, a 10 min detector purge, a 60 min detector equilibrium, using the narrow standards, and using the samples in order. The system can report the Mw, Mn, Mp, polydispersity, %<1000, and %<500 values. Polydispersity is determined by calculating the ratio of the measured weight average molecular weight to a value of the measured number average molecular weight.

Suitable curable polyester resins also preferably include structural features that help protect ester linkages of the resin against hydrolytic degradation. In preferred embodiments, at least a portion of the ester linkages of the polyester carrier resin are protected against hydrolytic degradation by hydrophobic moieties pendant from the polyester backbone that are in relatively close proximity to the ester groups. Without wishing to be bound, it is believed that steric hindrance provided by these proximal moieties plays a role in such protection of the nearby ester moieties.

To provide such protection, it is desirable that the pendant moieties are no farther than about 10, preferably no farther than about 5, and even more preferably no farther than about 3 backbone atoms from the ester group being protected. One or more of such protecting groups may be associated with each ester group. If more than one such protecting group is present, the groups may be on one or both sides of the protected ester group. In some instances, a particular protecting group may be positioned in sufficiently close proximity to more than one ester group so as to provide protection to both of the ester groups.

Preferred protecting groups are nonpolar to help create a hydrophobic environment in proximity to protected ester groups. As used herein, the term nonpolar means that the ratio of carbon atoms to other atoms (not including H) in the moiety is at least 4:1. This helps to ensure that the protecting group exhibits essentially no dipole moment in the carrier resin. Under this definition, the hydroxyl functional monovalent moiety —CH₂CH₂CH₂CH₂OH would be nonpolar, whereas the hydroxyl functional monovalent moiety —CH₂CH₂CH₂OH would be polar.

Generally, a protecting group of the present invention comprises at least one carbon atom but does not include so many carbon atoms so as to be large enough to unduly increase the viscosity of the colorant component. Accordingly, the protecting group desirably includes less than about 50, preferably less than about 20 carbon atoms, and more preferably less than about 7 carbon atoms. Preferred protecting groups useful in the present invention include but are not limited to linear, straight, cyclic, fused, and/or branched hydrocarbyl moieties (that is, groups including only C and H atoms) that may be alkyl, aryl, and/or alkaryl. More preferred hydrocarbyl protecting groups include from 1 to 4 carbon atoms, such as methyl, ethyl, propyl, isopropyl, butyl, isobutyl, sec-butyl, combinations of these and the like.

Optionally, protecting groups of the present invention may include at least one heteroatom such as O, N, S, P, combinations of these, and the like. If one or more hetero atoms are present, it is preferred that the ratio of carbon atoms to hetero and other non-hydrogen atoms is at least 5:1 or greater and there are at least 4 carbon atoms between hetero atoms if more than one hetero atom is present. Thus, preferred protecting groups desirably exclude sulfonate (in which S and O can be viewed as being adjacent), nitrate or nitrite (in which N and O can be viewed as being adjacent), phosphonate (in which P and O can be viewed as being adjacent), and the like.

In particularly preferred embodiments, first and second protecting groups are pending from carbon backbone atom(s) that are alpha and/or beta, preferably beta, to an ester group. It is preferred that at least two protecting groups are pendant from the backbone within two carbon atoms of an ester group to be protected. More preferably, the protecting groups are pendant from the same backbone carbon atom so as to provide a neo structure. According to an illustrative mode of practice, neo structures are easily obtained by deriving the polyester from branched diols incorporating a neo structure, described further below. In an illustrative embodiment, R¹ is ethyl and R² is butyl, isobutyl, or sec-butyl. An example of a backbone structure having a neo carbon in which the protecting groups are in a beta position relative to ester groups is the following

—C(O)OCH₂C(R¹)(R²)CH₂O(O)C—

wherein each of R¹ and R² is independently a protecting group pendant from the backbone carbon atom this is in the beta position relative to first and second ester linkages. Consequently, the R¹ and R² groups protect both of these ester groups. Note that the backbone carbon atom at the beta position is a neo carbon in the sense that this carbon is attached to four other carbon atoms including the two adjacent backbone carbon atoms and two carbon atoms of the pendant R¹ and R² groups. It has been found that neo structures such as this provide excellent protection against hydrolytic degradation for nearby ester groups.

Other exemplary protected backbone structures include the following, wherein each R¹ and R² independently is as defined above:

—C(O)OCH₂CH(R¹)CH₂O(O)C—

—C(O)OCH(R²)CH(R¹)CH₂O(O)C—

—C(O)OCH₂C(R¹)₂O(O)C—

—C(O)OCH(R²)CH(R¹)O(O)C—

—C(O)OCH₂CH(R²)CH(R¹)CH₂O(O)C—

—C(O)OCH₂C(R¹)(R²)C(R¹)(R²)CH₂O(O)C—

Preferred embodiments of the polyester carrier resin are linear. Linear in this context means that at least about 80 weight percent, preferably at least 90 weight percent, more preferably at least 95 weight percent, and most preferably substantially all of the resin is obtained from difunctional materials (such as diacids, diols, difunctional monomers that include or function as if they include an acid and an alcohol moiety such as caprolactone or the like) and monofunctional reactants used for end-capping. Using a linear architecture helps to keep polydispersity and viscosity low as the molecular weight builds. Thus, monomeric, oligomeric, or resin constituents having more than two polymerizable groups, such as triols, tetrols, tri-acids, materials comprising a combination of three or more OH and acid groups, and the like, desirably are excluded from the polymerizable ingredients used to make the preferred linear polyester embodiments.

The polyester carrier resin is preferably thermosetting such that the resin can be cured using one or more curing mechanisms. Thermosetting capabilities can be provided by any one or more of a wide variety of moieties that are capable of undergoing crosslinking reactions such as those that crosslink in the presence of a suitable energy flux and/or in the presence of a suitable material such as an initiator, catalyst, crosslinking agent, and/or the like. Examples of crosslinkable moieties include OH, acid or salt thereof, NCO, free radically polymerizable groups, groups that crosslink via cationic mechanisms, combinations of these, and the like. The polyester carrier resin can include one or more different kinds of curable moieties, if desired.

Desirably, the curing functionality incorporated into the polyester carrier resin comprises free radically polymerizable functionality. Prior to initiating curing, these groups may provide compositions with relatively long shelf life that resist premature curing reactions in storage. At the time of use, curing can be initiated on demand with good control by using one or more suitable curing techniques. Illustrative curing techniques include but are not limited to exposure to thermal energy; exposure to one or more types of electromagnetic energy such as visible light, ultraviolet light, infrared light, or the like; exposure to accelerated particles such as e-beam energy; contact with chemical curing agents such as by using peroxide initiation with styrene and/or a styrene mimetic; peroxide/amine chemistry; OH/NCO chemistry; combinations of these; and the like. When curing of such functionality is initiated, crosslinking may proceed relatively rapidly so resultant coatings develop early green strength. Such curing typically proceeds substantially to completion under wide range of conditions to avoid undue levels of leftover reactivity.

Representative examples of free radically polymerizable moieties suitable in the practice of the present invention include epoxy groups, (meth)acrylate groups, olefinic carbon-carbon double bonds, allyloxy groups, alpha-methyl styrene groups, (meth)acrylamide groups, cyanate ester groups, (meth)acrylonitrile groups, vinyl ethers groups, combinations of these, and the like. The term “(meth)acryl”, as used herein, encompasses acryl and/or methacryl unless otherwise expressly stated.

The polyester carrier resin desirably is obtained from ingredients comprising a difunctional nucleophilic component such as a diol; a diacid or a di-acid anhydride and/or salt of a diacid; optionally a species comprising both an acid (or anhydride or salt thereof) and OH functionality (including materials such as caprolactone or other lactone(s) that includes a single ester moiety that can ring open to both acid-like and OH-like functionalities), and optionally one or more monofunctional end capping ingredients. The ingredients used to prepare the polyester carrier resin may be aliphatic or aromatic, but preferably are aliphatic for better weathering characteristics.

In one preferred embodiment, at least one of the difunctional components desirably includes a branched structure that serves to provide protecting groups (preferably nonpolar protecting groups) in the resultant resin, and at least one of the difunctional components includes curing functionality. In some modes of practice, both acid and OH functional materials include branching and curing functionality. In other modes of practice, a diol ingredient includes a branched structure, and a diacid (or salt or anhydride thereof) includes curing functionality such as unsaturation. The unsaturation can be part of the backbone or can be in a pendant moiety in any modes of practice.

Exemplary branched diols useful for making the polyester carrier resin have the formula

HO—X¹—R³—X²—OH

wherein each of X¹ and X² independently represents a single bond or an alkylene group of 1 to 3 carbon atoms such as —CH₂—, —CH₂CH₂—, and the like; wherein R³ represents a branched hydrocarbyl structure that may include one or more heteroatoms; and wherein R³ preferably is nonpolar as defined herein. Representative embodiments of R³ include

—CR¹R²—, —CR⁴—CR⁵—, —CR¹R²—CHR⁴—, and —CHR¹—

wherein each of R¹ and R² independently is as defined above and each of R⁴ and R⁵ independently is defined in accordance with the definitions for R¹ and/or R².

Specific examples of branched diols having a neo carbon structure include 2-ethyl-2-butyl-1,3-propane diol, 2-ethyl-2-secbutyl-1,3-propane diol, 2-ethyl-2-isobutyl-1,3-propane diol, 2-methyl-2-butyl-1,3-propane diol, 2-methyl-2-isobutyl-1,3-propane diol, 2-methyl-2-secbutyl-1,3-propane diol, 2-propyl-2-butyl-1,3-propane diol, 2-propyl-2-isobutyl-1,3-propane diol, 2-propyl-2-secbutyl-1,3-propane diol, 2-isopropyl-2-butyl-1,3-propane dial, 2-isopropyl-2-isobutyl-1,3-propane diol, 2-isopropyl-2-secbutyl-1,3-propane diol, 2-methyl-2-propyl-1,3-propane diol, 2-methyl-2-isopropyl-1,3-propane diol, 2-2 dimethyl-propane diol (neopentyl glycol), combinations of these and the like.

Other examples of suitable branched diols would include 2-methyl-3methyl-1,4 butane diol, 2-methyl-3-ethyl-1,4 butane diol, 2-methyl-3-propyl-1,4 butane diol, 2-methyl-3-isopropyl-1,4 butane diol, 2-methyl-3-butyl-1,4 butane diol, 2-methyl-3-isobutyl-1,4 butane diol, 2-methyl-3-secbutyl-1,4 butane diol, 2-ethyl-3-methyl-1,4 butane diol, 2-ethyl-3-ethyl-1,4 butane diol, 2-ethyl-3-propyl-1,4 butane diol, 2-ethyl-3-isopropyl-1,4 butane dial, 2-ethyl-3-butyl-1,4 butane diol, 2-ethyl-3-isobutyl-1,4 butane diol, 2-ethyl-3-secbutyl-1,4 butane diol, 2-propyl-3-methyl-1,4 butane diol, 2-propyl-3-ethyl-1,4 butane diol, 2-propyl-3-propyl-1,4 butane diol, 2-propyl-3-isopropyl-1,4 butane diol, 2-propyl-3-butyl-1,4 butane diol, 2-propyl-3-isobutyl-1,4 butane diol, 2-propyl-3-secbutyl-1,4 butane diol, 2-isopropyl-3-methyl-1,4 butane diol, 2-isopropyl-3-ethyl-1,4 butane diol, 2-isopropyl-3-propyl-1,4 butane diol, 2-isopropyl-3-isopropyl-1,4 butane diol, 2-isopropyl-3-butyl-1,4 butane diol, 2-isopropyl-3-isobutyl-1,4 butane diol, 2-isopropyl-3-secbutyl-1,4 butane diol, 2-butyl-3-methyl-1,4 butane diol, 2-butyl-3-ethyl-1,4 butane diol, 2-butyl-3-propyl-1,4 butane diol, 2-butyl-3-isopropyl-1,4 butane diol, 2-butyl-3-butyl-1,4 butane dial, 2-butyl-3-isobutyl-1,4 butane diol, 2-butyl-3-secbutyl-1,4 butane diol, 2-isobutyl-3-methyl-1,4 butane diol, 2-isobutyl-3-ethyl-1,4 butane diol, 2-isobutyl-3-propyl-1,4 butane diol, 2-isobutyl-3-isopropyl-1,4 butane diol, 2-isobutyl-3-butyl-1,4 butane diol, 2-isobutyl-3-isobutyl-1,4 butane dial, 2-isobutyl-3-secbutyl-1,4 butane diol, 2-secbutyl-3-methyl-1,4 butane diol, 2-secbutyl-3-ethyl-1,4 butane diol, 2-secbutyl-3-propyl-1,4 butane diol, 2-secbutyl-3-isopropyl-1,4 butane diol, 2-secbutyl-3-butyl-1,4 butane diol, 2-secbutyl-3-isobutyl-1,4 butane diol, 2-secbutyl-3-secbutyl-1,4 butane diol, combinations of these, and the like.

Exemplary unsaturated diacids (or salts or anhydrides thereof) useful for making the polyester carrier resin may have the formula

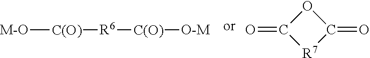

wherein each of R⁶ and R⁷ is independently a divalent, unsaturated moiety in which the unsaturation may be in the backbone and/or in a moiety pendant from the backbone; and each M is independently H or a cation such as Na+, K+, Li+, NH₄+, combinations of these, and the like. R⁶ and R⁷ independently may be linear, branched, or part of a spyro, cyclic or fused structure.

Exemplary embodiments of R⁶ or R⁷ in which the unsaturation is part of the backbone may have the cis or trans structure

—X³—CR⁹═CR¹⁰—X⁴—

wherein each of X³ and X⁴ is independently a single bond or an unsaturated, divalent alkylene moiety of 1 to 20, preferably 1 to 10, more preferably 1 to 5 carbon atoms such as —CH₂—, —CH₂CH₂—, combinations of these, and the like; and each of R⁹ and R¹⁰ is independently H or a pendant nonpolar moiety including from 1 to 50, preferably 1 to 20, more preferably 1 to 10 carbon atoms. R9 and R10 may also be co-members of a ring structure.

Specific examples of unsaturated diacids (or an anhydride or a salt thereof) include maleic anhydride, fumaric acid, maleic acid, 4-cyclohexene-1,2-dicarboxylic acid or anhydride; combinations of these, and the like. The use of maleic anhydride is particularly preferred. This monomer can co-polymerize with dials in a manner that yields a resin product having desired low polydispersity without necessarily having to resort to purification techniques to isolate the narrow polydisperse product range that might be desired. Additionally, maleic anhydride reacts at relatively low temperature in the present context, and by-products are minimal.

Monomers including a hydroxyl group and an acid group, or precursors thereof (e.g. a lactone), also may be used as ingredients to make the polyester carrier resin. These monomers may also include other kinds of functionality, such free radically polymerizable functionality for instance, that does not polymerize during the making of the polyester resin, but may or may not participate in crosslinking reactions during curing. Such monomers are particularly useful, by way of example, in a multistage synthesis (described further below) of the polyester carrier resin to build molecular weight in a controlled way and to provide a resin intermediate with terminal OH groups. Examples of such reactants include materials such as lactones, combinations of these, and the like.

Monomers including epoxy functionality can be used to build molecular weight in a controlled fashion. For instance, a monoepoxide functional material can be reacted with an oligomer having co-reactive carboxylate functionality (e.g., —COOM, wherein M is H or a monovalent cation such as Na+, K+, Li+, NH₄+, etc.). The epoxy group reacts with the co-reactive carboxylate functionality to form an ester linkage and a secondary hydroxyl functionality. An exemplary monoepoxide is the Cardure E-10 material commercially available from Hexion Specialty Chemicals, Columbus, Ohio.

The resultant hydroxyl functionality can be exploited in various ways. As one option, the hydroxyl can be used to achieve cross-linking via reaction with co-reactive species optionally in the presence of a suitable catalyst. Alternatively, the hydroxyl can be left as is to help with pigment dispersion. As another option, the OH can be used to further build molecular weight stepwise in a controlled fashion such as by reacting the hydroxyl functional product with a fatty acid or the like to end cap the oligomer.

Monofunctional end-capping materials may also be used to make the polyester carrier resin. These can be used to build molecular weight in a controlled way and to convert polar end groups into nonpolar moieties for reduced viscosity. When terminal end groups of an intermediate are hydroxyl, exemplary monofunctional end-capping materials include saturated and unsaturated fatty acids or salts thereof. Preferred fatty acids include hydrocarbyl chains of from about 7 to about 20 carbon atoms, preferably 8 to 10 carbon atoms. Exemplary saturated and unsaturated fatty acids include capric acid, caprylic acid, 2-ethyl hexanoic acid, lauric, linoleic, oleic acid, pelargonic acid, soya fatty acid combinations of these, and the like.

The ingredients used to make the polyester carrier resin can be assembled in one or more reaction steps. A preferred reaction scheme proceeds through multiple steps as a way to control the molecular weight and to achieve the desired narrow polydispersity of the resin product. According to a first reaction step of this preferred scheme, a branched diol is reacted with a stoichiometric excess of a diacid, salt of a diacid, and/or diacid anhydride.

Generally, the molar ratio of the diacid (or salt or anhydride thereof) to the diol can impact the molecular weight and polydispersity of the resin product. Generally, molecular weight and polydispersity tend to increase as the ratio decreases, while molecular weight and polydispersity tend to decrease as the ratio increases. Consequently, higher ratios are preferred. However, using too much of an excess of the diacid reactant might provide little extra benefit and is less efficient. Balancing such concerns, this ratio desirably is in a range from at least about 1.5:1 to 20:1, preferably from about 1.8:1 to about 5:1. Using a molar ratio of about 3.59 would be suitable in one exemplary embodiment.

The reaction between the diol and diacid desirably occurs in an inert atmosphere. This can be accomplished by flushing a suitable reactor with a flow of inert gas such as nitrogen, carbon dioxide, argon, or the like. As the reaction proceeds, water desirably is removed by any suitable technique, such as by using a Dean-Stark apparatus, to help the reaction go to completion. The reactants may be heated to facilitate the reaction progress, while accounting for an exotherm that typically might occur. For example, in one mode of practice, the reactants were heated to 80° C., and an exotherm of 105° C. was observed. The reaction may be allowed to proceed until all OH groups are consumed.

The product of this first step is a polyester intermediate having terminal acid groups. The molecular weight of this first intermediate desirably is built up step-wise in one or more additional reaction steps in order to build additional molecular weight. Desirably, polar moieties can be converted nonpolar moieties to promote lower viscosity characteristics if desired. A preferred mode of practice accomplishes this build-up of molecular weight in two stages in second and third reaction steps.

In a second reaction step, the acid functional polyester intermediate is reacted with a stoichiometric excess of a an epoxide functional monomer. The monomer may optionally include other functionality that is substantially inert in the context of the polymerization reaction but might be reactive in other contexts. For instance, the monomer might include unsaturation or the like. The epoxy group reacts with the acid functionality to form a polyester linkage. A pendant, secondary hydroxyl group is also produced. In practical effect, the terminal acid groups are converted to terminal OH groups will building molecular weight step-wise.

The ratio of such an epoxide functional monomer to the polyester intermediate resin desirably is sufficiently high so as to convert at least substantially all of the terminal acid groups of the resin to terminal OH groups. Generally, using a molar ratio of monomer to resin intermediate about from about 4:1 to about 20:1 would be suitable. In an illustrative embodiment, about 3.5 moles of monomer are added per mole of diacid (or salt or anhydride thereof) used in the initial reaction step.

The reaction of the epoxide functional monomer with the polyester intermediate may occur in the same reaction flask under an inert atmosphere without isolation or work up of the polyester intermediate. One could isolate the reaction product if desired, but this is not required. The reaction step desirably occurs by slowly adding the epoxide functional monomer to the product mixture resulting from the first reaction step over a suitable time period, e.g., from about 10 seconds to about 48 hours, desirably about 5 minutes to about 8 hours, more desirably from about 15 minutes to about 2 hours. In one mode of practice, the addition occurred over 30 minutes. This addition may occur with or without heating, but desirably occurs while maintaining the mixture at about the same temperature as occurred in the latter stages of the first reaction step. After the addition, the temperature of the mixture can be raised, such as to about 120° C. in an illustrative mode or practice, and maintained at such a temperature until the acid groups are all consumed. The reaction product is now a second polyester intermediate with terminal, secondary OH groups. In a third reaction step, the terminal, secondary OH groups of the second polyester resin intermediate are converted to nonpolar hydrocarbyl groups. This step also further builds molecular weight in a controlled fashion. This reaction step can occur in the same reaction vessel without isolation or work up. This third step can be accomplished by reacting the second polyester resin intermediate with a stoichiometric excess of one or more saturated and/or unsaturated fatty acids (or salts or anhydrides thereof). This can be accomplished by slowly adding the fatty acid to the reaction mixture over a suitable time period. Exemplary time periods are in the range from about one second to about 48 hours, desirably about 30 seconds to about 8 hours, more desirably about 5 minutes to about 2 hours. In one mode of practice, the addition occurred over 15 minutes. A material such as xylene can be added to facilitate phase separation between aqueous and organic phases in order to remove water from the reaction mixture as the reaction proceeds. The third reaction step can occur with heating in the same temperature ranges that are suitable for the first and second reaction steps.

After the addition, the temperature may be raised to a suitable level, e.g., about 220° C., to facilitate the reaction and to allow azeotropic distillation. This removes water to help drive the reaction toward completion. The resultant polyester product is a polyester carrier resin suitable in the practice of the present invention.

In some instances, adding fatty acid according to the reaction scheme described above can cause foaming in that the fatty acid may tend to act like a surfactant. To minimize or avoid foaming, an alternative reaction approach can be practiced in which the Cardura E-10 material is pre-reacted with a monofunctional fatty acid. According to this approach, a stoichiometric excess of Cardura E-10 material is reacted with a monofunctional fatty acid. Conveniently, this reaction may occur neat at a relatively low temperature, e.g., about 150° C., in an inert atmosphere, such as nitrogen. The adduct product includes an ester linkage connecting the residues of the two reactants. The adduct further includes secondary hydroxyl functionality.

Next, maleic anhydride and a suitable diol such as BEPD are combined and reacted with the adduct to form the desired polyester carrier resin. This reaction desirably includes about 97 to about 98 percent by weight solids and a small solvent such as xylene, toluene, other aromatics, methyl isobutyl ketone (MIBK), cyclohexanone, other ketones, and/or combinations of these, for azeotropic reflux. Water is removed from the reaction medium in order to help drive the reaction to completion. The reaction may occur near or at the boiling point of the reaction mixture in an inert atmosphere.

In addition to the polyester carrier resin, the colorant component preferably further includes one or more colorants to help provide a desired color and/or other desired visual or optical effect (e.g., IR reflection properties, retroreflective properties, etc.). Representative colorants impart coloration (including white or black coloration) and opacity to the disclosed gel coat compositions. Other examples of useful colorants include one or more materials that impart visual effects, including materials such as fluorescent materials, pearlescent materials, iridescent materials, metallic materials, flip-flop pigments, silica, polymeric beads, reflective and non-reflective glass beads, mica, combinations of these, and the like.

A wide variety of colorant material(s) can be used, including pigments, stains, dyes, and the like. These may be organic or inorganic. Pigments are preferred for use as colorants. As compared to many dyes, many pigments tend to have better outdoor durability and resistance to fading upon exposure to sun and the elements. Pigments useful in the invention may be organic and/or inorganic.

Representative pigments can be commercially obtained as dry materials, such as powder, pellets, or the like, or can be obtained in the form of a paste or other dispersion of the dry pigment in a compatible carrier. Exemplary dispersions may include from about 5 to about 65 wt. %, preferably about 10 to about 50 wt. %, more preferably about 15 to about 40 wt. % dry pigment solids based on the total weight of the dispersion. The dispersion may also contain wetting agents, dispersing agents, inhibitors, and other conventional additives in conventional amounts. Suitable carriers can be solvents and/or resins. Resins include unsaturated polyester resins, saturated polyester resins, urethane diacrylates, acrylic silicones, or other carriers that will be familiar to those skilled in the art. The pigment dispersion may be prepared in a variety of ways such as by adding the pigment and other ingredients to the carrier. The ingredients then are mixed in a grinding machine. Optionally, a portion of the colorant(s) to be used in a gel coat composition also may be incorporated into one or more gel coat resin component(s) and/or other color components to allow for maximum flexibility in custom color preparation.

Useful colorants in the form of dyes, stains, pigments, and the like are well known in the art and include materials listed in the Colour Index, as published by the Society of Dyers and Colourists (Bradford, England. Pigments are preferred for use as colorants. As compared to many dyes, many pigments tend to have better outdoor durability and resistance to fading upon exposure to sun and the elements. Pigments useful in the invention may be organic and/or inorganic. Representative inorganic pigments include carbon black (Cabot Monarch 120, Cabot Regal 300R, Cabot Regal 350R, Vulcan X72, and Aztech ED 8200), titania (TiO₂), combinations of these, and the like.

Representative organic pigments include phthalocyanines, anthraquinones, perylenes, carbazoles, monoazo- and disazobenzimidazolones, isoindolinones, monoazonaphthols, diarylidepyrazolones, rhodamines, indigoids, quinacridones, diazopyranthrones, dinitranilines, pyrazolones, dianisidines, pyranthrones, tetrachloroisoindolinones, dioxazines, monoazoacrylides, anthrapyrimidines, and the like. It will be recognized by those skilled in the art that organic pigments will be differently shaded, or even have different colors, depending on the functional groups attached to the main molecule.

Commercial examples of useful organic pigments include those described in The Colour Index, Vols. 1-8, Society of Dyers and Colourists, Yorkshire, England having the designations Pigment Blue 1, Pigment Blue 15, Pigment Blue 15:1, Pigment Blue 15:2, Pigment Blue 15:3, Pigment Blue 15:4, Pigment Blue 15:6, Pigment Blue 16, Pigment Blue 24, and Pigment Blue 60 (blue pigments); Pigment Brown 5, Pigment Brown 23, and Pigment Brown 25 (brown pigments); Pigment Yellow 1, Pigment Yellow 3, Pigment Yellow 10, Pigment Yellow 12, Pigment Yellow 13, Pigment Yellow 14, Pigment Yellow 16, Pigment Yellow 17, Pigment Yellow 24, Pigment Yellow 65, Pigment Yellow 73, Pigment Yellow 74, Pigment Yellow 83, Pigment Yellow 95, Pigment Yellow 97, Pigment Yellow 105, Pigment Yellow 108, Pigment Yellow 109, Pigment Yellow 110, Pigment Yellow 111, Pigment Yellow 113, Pigment Yellow 128, Pigment Yellow 129, Pigment Yellow 138, Pigment Yellow 139, Pigment Yellow 150, Pigment Yellow 154, Pigment Yellow 156, and Pigment Yellow 175 (yellow pigments); Pigment Green 1, Pigment Green 7, Pigment Green 10, and Pigment Green 36 (green pigments); Pigment Orange 5, Pigment Orange 15, Pigment Orange 16, Pigment Orange 31, Pigment Orange 34, Pigment Orange 36, Pigment Orange 43, Pigment Orange 48, Pigment Orange 51, Pigment Orange 60, and Pigment Orange 61 (orange pigments); Pigment Red 3, Pigment Red 4, Pigment Red 5, Pigment Red 7, Pigment Red 9, Pigment Red 17, Pigment Red 22, Pigment Red 23, Pigment Red 38, Pigment Red 48, Pigment Red 48:1, Pigment Red 48:2, Pigment Red 49, Pigment Red 52:1, Pigment Red 52:179, Pigment Red 81:1, Pigment Red 81:2, Pigment Red 81:3, 81:4, Pigment Red 112, Pigment Red 122, Pigment Red 123, Pigment Red 149, Pigment Red 166, Pigment Red 168, Pigment Red 170, Pigment Red 177, Pigment Red 179, Pigment Red 190, Pigment Red 202, Pigment Red 206, Pigment Red 207, Pigment Red 209, and Pigment Red 224 (red pigments); Pigment Violet 19, Pigment Violet 23, Pigment Violet 37, Pigment Violet 32, and Pigment Violet 42 (violet pigments); and Pigment Black 6 or 7 (black pigments).

If a colorant in the form of pigment is used, using one or more dispersants may be desired in some instances in order to stabilize the dispersion of the pigment in the polyester earner resin. The choice of dispersant depends on factors such as the type of pigment used, the nature of the polyester carrier resin, the nature of other ingredients that may be incorporated into the colorant component, and the like.

In addition to the colorant(s), optional dispersant material, and the polyester resin having low polydispersity and protected ester linkages, the colorant component also may include one or more additional ingredients, including one or more additional resins (such as those described as being useful in the gel coat resin component), reactive diluents, and/or other additives. These are described in more detail below inasmuch as such additional ingredients also may be used optionally in the gel resin component.

The gel coat resin component generally includes at least one curable polyester resin. A variety of polyester resins may be used in this component. In addition to the polyester resin described above with respect to the colorant component, other representative polyester resins include the unsaturated resins that are described in U.S. Pat. Nos. 4,742,121, 5,567,767, 5,571,863, 5,688,867, 5,777,053, 5,874,503 and 6,063,864 and in PCT Published Application Nos. WO 94/07674 A1, WO 00/23495 A1 and WO 03/101918A2.

In some embodiments, the polyester resin of the gel coat resin component may be prepared from the condensation of one or more carboxylic acids (such as mono, di- or poly-functional unsaturated or saturated carboxylic acids) or their derivatives (such as acid anhydrides, C1 to C8 alkyl esters, etc.) with one or more alcohols (including mono-functional, di-functional and poly-functional alcohols). The carboxylic acid or derivative may for example be a mixture of an unsaturated carboxylic acid or derivative and a saturated carboxylic acid or derivative. The unsaturated carboxylic acids or their derivatives may for example have about 3 to about 12, about 3 to about 8, or about 4 to about 6 carbon atoms.

Representative unsaturated carboxylic acids and their derivatives include maleic acid, fumaric acid, chloromaleic acid, itaconic acid, citraconic acid, methylene glutaric acid, mesaconic acid, acrylic acid, methacrylic acid, and esters or anhydrides thereof. Representative unsaturated carboxylic acids and their derivatives include maleic, fumaric acids, fumaric esters and anhydrides thereof.

An unsaturated carboxylic acid or its derivative may for example be present in an amount from about 20 to about 90 mole percent, about 35 to about 75 mole percent, or about 50 to about 65 mole percent of the acids or acid derivatives used to make the unsaturated polyester resin. The saturated carboxylic acids and their derivatives may for example have from about 8 to about 18, about 8 to about 15, or about 8 to about 12 carbon atoms. Representative saturated carboxylic acids and their derivatives may be aromatic, aliphatic or a combination thereof, and include succinic acid, glutaric acid, d-methylglutaric acid, adipic acid, sebacic acid, pimelic acid, phthalic anhydride, o-phthalic acid, isophthalic acid, terephthalic acid, dihydrophthalic acid, tetrahydrophthalic acid, hexahydrophthalic acid or anhydride, tetrachlorophthalic acid, chlorendic acid or anhydride, dodecanedicarboxylic acids, nadic anhydride, cis-5-norbornene-2,3-dicarboxylic acid or anhydride, dimethyl-2,6-naphthenic dicarboxylate, dimethyl-2,6-naphthenic dicarboxylic acid, naphthenic dicarboxylic acid or anhydride and 1,4-cyclohexane dicarboxylic acid. Other representative carboxylic acids include ethylhexanoic acid, propionic acid, trimellitic acid, benzoic acid, 1,2,4-benzenetricarboxylic acid, 1,2,4,5-benzenetetracarboxylic acid and anhydrides thereof.

Representative aromatic saturated carboxylic acids include o-phthalic acid, isophthalic acid and their derivatives. Representative aliphatic saturated carboxylic acids include 1,4-cyclohexane dicarboxylic acid, hexahydrophthalic acid, adipic acid and their derivatives. The saturated carboxylic acids or their derivatives may for example be present in an amount from about 10 to about 80 mole percent, about 25 to about 65 mole percent, or about 35 to about 50 mole percent of the acids or acid derivatives used to make the unsaturated polyester resin. Also, an aromatic carboxylic acid may for example be present in an amount from 0 to 100 percent, from 0 to about 50 percent, or from 0 to about 25 percent of the saturated acids or acid derivatives used to make the unsaturated polyester resin, and an aliphatic carboxylic acid may for example be present in an amount from 0 to 100 percent, from about 50 to 100 percent, or from about 75 to 100 percent of the saturated acids or acid derivatives used to make the unsaturated polyester resin.

Representative alcohols for use in making the unsaturated polyester resins include alkanediols and oxa-alkanediols such as ethylene glycol, 1,2-propylene glycol, propane-3-diol, 1,3-butylene glycol, butene-1,4-diol, hexane-1,6-diol, diethylene glycol, triethylene glycol, polyethylene glycol, cyclohexane-1,2-diol, 2,2-bis-(p-hydroxycyclohexyl)-propane, 5-norbornene-2,2-dimethylol, 2,3-norbornene diol, cyclohexane dimethanol, and the like. Alcohols having a neo-structure such as 1,2-propanediol, 2-methyl 1,3-propanediol, 2,2-dimethyl heptanediol, 2,2-dimethyl octanediol, 2,2-dimethyl-1,3-propanediol (neopentyl glycol), pentaerythritol, dipentaerythritol, tripentaerythritol, trimethylol propane, di-trimethylol propane, 2,2,4-trimethyl-1,3-pentanediol, 2-butyl-2-ethyl-1,3-propanediol, 3-hydroxy-2,2-dimethylpropyl 3-hydroxy-2,2-dimethyl propanate, and the like may be preferred. Monofunctional alcohols may also be used to prepare the unsaturated polyester resin. Representative monofunctional alcohols include benzyl alcohol, cyclohexanol, 2-ethylhexyl alcohol, 2-cyclohexyl ethanol, 2,2-dimethyl-1-propanol and lauryl alcohol. Where a monofunctional alcohol is used, the amount may for example be less than about 10 mole percent, or less than about 5 mole percent of the alcohols used to make the unsaturated polyester resin.

The polyester gel coat resin may be prepared by esterification techniques that will be familiar to those skilled in the art, for example by using catalysts (e.g., esterification or transesterification catalysts) that will likewise be familiar to those skilled in the art. The esterification process is typically carried out until the polyester attains an acid number corresponding to the desired molecular weight. For example, the final acid number may be from about 7 to about 30, the number average molecular weight (Mₙ) may be from about 800 to about 3600, and the weight average molecular weight (M_{w}) may be from about 1,300 to about 11,000. The acid number may be reduced by increasing the reaction temperature, carrying out the reaction for a longer period of time, or by adding an acid neutralizer as will be familiar to those skilled in the art.

The polyester gel coat resin also may be formed by reacting an oligoester having a weight average molecular weight of about 200 to about 4000 with a diisocyanate and a hydroxyalkyl(meth)acrylate to provide a urethane acrylate having terminal vinyl groups, as described in the above-mentioned U.S. patent application Ser. No. 10/521,225. The urethane acrylate resin may be used as is, or in a mixture with another unsaturated polyester resin such as an aliphatic or aromatic unsaturated polyester resin.

In illustrative embodiments, the polyester gel coat resin(s) may represent about 25 to about 94 wt. %, about 30 to about 89 wt. %, or about 40 to about 79 wt. % of the gel coat resin component.

One or more optional ingredients may be incorporated into a colorant component, a gel resin component, and/or a gel coat composition incorporating one or more colorant components and/or one or more gel resin components. One class of optional ingredients includes one or more reactive diluents. A reactive diluent generally refers to a relatively low molecular weight material that includes functionality that is co-reactive with the curing functionality of the polyester carrier resin and/or at least one curable resin included in the gel resin (second) component described further below. The reactive diluent(s) function as diluents or solvents, as viscosity reducers, as binders when cured, and/or as crosslinking agents. The reactive diluent(s) also can be selected to enhance the characteristics or performance of a colorant composition, a gel coat resin component, a curable gel coat composition, and/or a cured gel coat.

Generally, materials suitable as reactive diluents have a weight average molecular weight of less than about 700, desirably from about 50 to about 500. Materials including free radically reactive functionality are presently preferred.

The amount of reactive diluent to be included in a colorant composition, a gel coat resin component, a curable gel coat composition, and/or a cured gel coat, as the case may be, may vary over a wide range. As general guidelines, a colorant composition, a gel coat resin component, a curable gel coat composition, and/or a cured gel coat of the present invention may contain from about 2 to about 99, preferably 25 to 90 weight percent of reactive diluent based upon the total weight of the component, composition, or coating.

The reactive diluent(s) may be mono-, di-, tri-, tetra- or otherwise multifunctional in terms of curable functionality. Representative examples of monofunctional, radiation curable monomers suitable for use as the reactive diluent(s) include styrene, alpha-methylstyrene, substituted styrene, vinyl esters, diallyl phthalate, triallyl cyanurate, vinyl ethers, N-vinyl-2-pyrrolidone, (meth)acrylamide, N-substituted (meth)acrylamide, octyl (meth)acrylate, nonylphenol ethoxylate (meth)acrylate, isononyl (meth)acrylate, isobornyl (meth)acrylate, 2-(2-ethoxyethoxy)ethyl (meth)acrylate, propoxy ethyl (meth)acrylate, propoxylated neopentyl glycol di(meth)acrylate, 2-ethylhexyl (meth)acrylate, lauryl (meth)acrylate, beta-carboxyethyl (meth)acrylate, isobutyl (meth)acrylate, cycloaliphatic epoxide, alpha-epoxide, 2-hydroxyethyl (meth)acrylate, (meth)acrylonitrile, maleic anhydride, itaconic acid, isodecyl (meth)acrylate, dodecyl (meth)acrylate, n-butyl (meth)acrylate, methyl (meth)acrylate, hexyl (meth)acrylate, (meth)acrylic acid, N-vinylcaprolactam, stearyl (meth)acrylate, hydroxy functional caprolactone ester (meth)acrylate, isooctyl (meth)acrylate, hydroxyethyl (meth)acrylate, hydroxymethyl (meth)acrylate, hydroxypropyl (meth)acrylate, hydroxyisopropyl (meth)acrylate, hydroxybutyl (meth)acrylate, hydroxyisobutyl (meth)acrylate, tetrahydrofurfuryl (meth)acrylate, combinations of these, and the like.

Multifunctional reactive diluent(s) may be used an alternative to, or in combination with, the monofunctional reactive diluent(s). These may be used for a variety of reasons, including to enhance one or more properties of the cured coating, including crosslink density, hardness, tackiness, mar resistance, or the like. If one or more multifunctional materials are present, the reactive diluent may comprise from 0.5 to about 100, preferably 0.5 to 85, and more preferably from about 0.5 to about 50 weight percent of such materials based upon the total weight of the reactive diluent. Examples of such higher functional, radiation curable monomers include ethylene glycol di(meth)acrylate, hexanediol di(meth)acrylate, triethylene glycol di(meth)acrylate, tetraethylene glycol di(meth)acrylate, trimethylolpropane tri(meth)acrylate, ethoxylated trimethylolpropane tri(meth)acrylate, glycerol tri(meth)acrylate, pentaerythritol tri(meth)acrylate, pentaerythritol tetra(meth)acrylate, and neopentyl glycol di(meth)acrylate, combinations of these, and the like. One useful multifunctional reactive diluent oligomer with free radically curable functionality may be obtained by reacting an unsaturated carboxylic acid such as (meth)acrylic acid with an epoxy functional material such as the 2.3-epoxypropyl neodecanoate commercially available under the trade designation Cardura E-10.

In addition to one or more reactive diluents, other optional ingredients that could be used will be familiar to those skilled in the art. These include extender fillers, one or more additional resins, solvent, antistatic agents, biocides, fungicides, dispersants, skid resistant agents, agents that protect against ultraviolet exposure, suppressants, surface tension agents, air release agents, initiators, photoinitiators, slip modifiers, thixotropic agents, foaming agents, antifoaming agents, flow or other rheology control agents, waxes, oils, plasticizers, antioxidants, stabilizers, catalysts, gloss enhancing agents, gloss reducing agents, opacifiers, combinations of these and the like.

Examples of fillers include chopped or milled fiberglass, talc, silicone dioxide, titanium dioxide, wollastonite, mica, alumina trihydrate, clay, calcium carbonate, magnesium carbonate, barium carbonate, calcium sulfate, magnesium sulfate and barium sulfate.

Suppressants may reduce volatile organic emissions, and include materials described in the above-mentioned U.S. Pat. No. 5,874,503. When employed, the suppressant amount may for example be up to about 2 wt. %, up to about 1.5 wt. %, or from about 0.1 to about 1 wt. % of the gel coat composition.

Surface tension agents may lower surface tension at the surface of an uncured or cured gel coat, and include silicones such as dimethyl silicones, liquid condensation products of dimethylsilane diol, methyl hydrogen polysiloxanes, liquid condensation products of methyl hydrogen silane diols, dimethylsilicones, aminopropyltriethoxysilane and methyl hydrogen polysiloxanes, and fluorocarbon surfactants such as fluorinated potassium alkyl carboxylates, fluorinated alkyl quaternary ammonium iodides, ammonium perfluoroalkyl carboxylates, fluorinated alkyl polyoxyethylene ethanols, fluorinated alkyl alkoxylates, fluorinated alkyl esters, and ammonium perfluoroalkyl sulfonates. Representative commercially available surface tension agents include BYK-306.™. silicone surfactant (from BYK-Chemie USA, Inc.), DC100 and DC200 silicone surfactants (from Dow Corning Co.), the MODAFLOW™ series of additives (from Solutia, Inc.) and SF-69 and SF-99 silicone surfactants (from GE Silicones Co.). When employed, the surface tension agent amount may for example be up to about 1 wt. %, or from about 0.01 to about 0.5 wt. % of the gel coat composition.

Air release agents may assist in curing the gel coat composition without entrapping air and thereby causing weakness or porosity. Typical air release agents are silicone or non-silicone materials including silicone defoamers, acrylic polymers, hydrophobic solids, and mineral oil based paraffin waxes. Commercially available air release agents include BYK-066, BYK-077, BYK-500, BYK-501, BYK-515, and BYK-555 defoamers (from BYK-Chemie USA, Inc.). When used, the air release agent amount may for example be up to about 1.5 wt. %, up to about 1 wt. %, or from about 0.1 to about 0.5 wt. % of the gel coat composition.

Initiators or catalysts may be added to a gel coat composition or components thereof. These may be added in a variety of ways. For instance, initiators and/or catalysts can be incorporated into a gel coat composition or component thereof proximal to the time of application to a substrate surface/Latent initiators or catalysts may be included in the gel coat composition or a component thereof as supplied, and then such are activated proximal to or during the application process. Representative initiators or catalysts include free-radical catalysts such as peroxide catalysts (e.g., benzoyl peroxide, methyl ethyl ketone peroxide, cumene hydroperoxide, and the like), azoalkane catalysts and commercially available initiators or catalysts such as DDM9 and DHD9 catalyst (from Atofina), HIGH POINT™ 90 catalyst (from Witco) and CADOX™ 50 catalyst (from Norac Co.). Representative radiation-activated or heat-activated initiators or catalysts include IRGACURE™ 819 initiator (from Ciba Specialty Chemicals) and cumene hydroperoxide. When used, the initiator or catalyst amount may for example be about 0.5 to about 3 wt. %, about I to about 2.5 wt. %, or about 1.2 to about and 2 wt. % of the unsaturated polyester resin weight.

A gel coat composition may be prepared in a variety of ways. According to one approach, ingredients comprising at least one colorant component and at least one gel coat resin component are blended in a suitable mixing vessel in any convenient order. If desired, some or all of the reactive diluent may be added prior to, during, and or after such blending to yield a mixture having the desired viscosity. The promoter amount may be adjusted or inhibitors may be added or adjusted to obtain a gel coat composition having a desired gel and cure time. At least one colorant (e.g., a pigment dispersion) is provided. Such colorant(s) may be added to the colorant component, the gel resin component, the gel coat composition, and/or combinations of these.

In some embodiments, it is preferred that the colorant component, gel resin component, and the resultant uncured, gel coating compositions of the present invention contain substantially no solvent. Substantially no solvent means that the uncured gel coating contains less than 10, preferably less than 2, more preferably less than 0.5 weight percent of solvent. Alternatively, in some embodiments, one or more of the colorant component, gel resin component, and/or resultant gel coat compositions of the present invention also optionally may incorporate a limited, moderate amount of a solvent component. Preferred solvents desirably have a relatively high flash point of at least about 50° C., preferably at least about 60° C. to minimize or avoid pinholes that could form when solvent is removed.

The compositions might include solvent for a variety of reasons such as when an ingredient is supplied in a solvent, to promote the desired level of wetting and adhesion, to reduce the viscosity of the composition to a level suitable for coating compositions, to reduce the surface tension of the composition to a desired level to wet a wide variety of substrates, and/or to provide a vapor barrier that forms over the gel coated compositions in situ during radiation curing to improve the quality of the cure. Even if a solvent is used, using lesser amounts of solvent tends to provide better quality gel coat features as compared to using greater amounts of solvent. Using more solvent than is needed may also increase the difficulty of drying the gel coating during radiation curing and could deteriorate the cured image appearance and properties. As general guidelines, one or more of the colorant component, gel resin component, and/or gel coat composition may comprise 0.1 to 40, preferably 0.25 to 15, more preferably 0.5 to about 10 weight percent of the solvent component.

The solvent component may comprise one or more solvents that may be aqueous or inorganic, polar or nonpolar, or the like. Organic solvents that are polar or nonpolar are more preferred inasmuch as such solvents tend to dry more readily during radiation curing. Preferred organic solvents also promote compatibility with a wide range of polymer substrates by reducing the surface tension of the gel coat composition to the desired level. Also, preferred solvents should be compatible with the pigment dispersion so that the solvent does not cause instability. As another desirable characteristic, solvents of the present invention are desirably liquids at the gel coating temperature and undergo substantially no polymerization through free radical polymerization mechanisms when radiation curable components of the formulations are radiation cured.

It can be appreciated, therefore, that a wide range of solvents may be used. Representative examples include water; alcohols such as isopropyl alcohol (IPA) or ethanol; ketones such as methyl ethyl ketone, cyclohexanone, or acetone; aromatic hydrocarbons; isophorone; butyrolactone; N-methylpyrrolidone; tetrahydrofuran; esters such as lactates, acetates, including propylene glycol monomethyl ether acetate (PM acetate), diethylene glycol ethyl ether acetate (DE acetate), ethylene glycol butyl ether acetate (EB acetate), dipropylene glycol monomethyl acetate (DPM acetate); iso-alkyl esters such as isohexyl acetate, isoheptyl acetate, isooctyl acetate, isononyl acetate, isodecyl acetate, isododecyl acetate, isotridecyl acetate or other iso-alkyl esters; combinations of these and the like. The esters, particularly those comprising branched aliphatic moieties such as iso-alkyl moieties, are one class of preferred solvent. These solvents provide numerous advantages. For instance, the materials are also excellent solvents for the radiation curable monomers, oligomers, and polymers. Further, these materials evaporate very easily, yet have relatively high flash points. Thus, these solvents are easily removed during radiation curing, yet do not significantly reduce the formulation flash point. A variety of branched, aliphatic ester solvents are commercially available under the trade designation EXXATE from ExxonMobil Corp. of Irving, Tex.

In preferred embodiments, relatively polar solvents such as isopropyl alcohol are less desirable then relatively nonpolar solvents in that polar solvents may have a strong affinity for the dispersants, if any, used to stabilize the pigment in the inks. This affinity can cause pigment agglomeration and destabilization. Solvents with static surface tension at 25° C. of greater than about 30 dynes/cm also are less preferred.

Gel coat compositions of the present invention may be used to form gel coats on a wide variety of substrates. Gel coats, for instance, may be useful on structures such as marine vessels or components thereof, storage tanks, motor vehicles or components thereof, aircraft or components thereof, sports equipment or components thereof, buildings and components thereof, fences and other man-made structures, and the like.

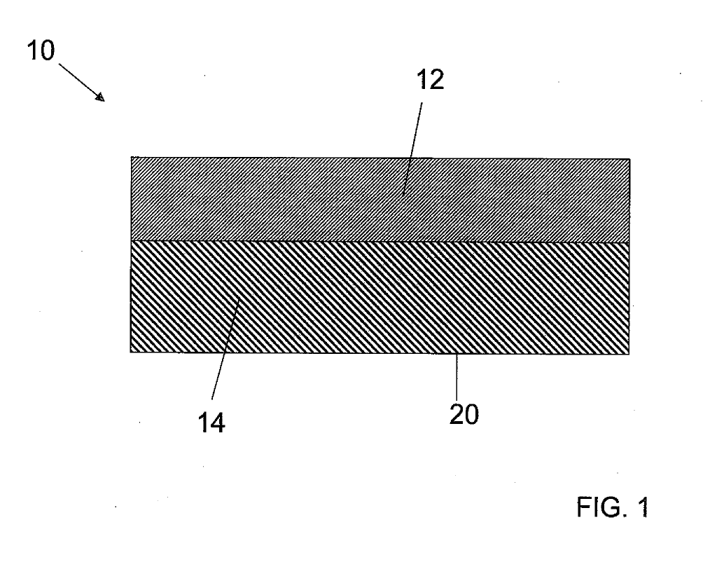

FIG. 1 schematically shows an illustrative composite structure 10 including a gel coat layer 12 of the present invention provided on a substrate 14. A wide variety of materials may be used to create substrate 14. These include paper; cardboard; wood or other natural or man-made cellulosic products; woven or nonwoven textiles; crystalline or amorphous metallic materials (including metals, metal alloys, intermetallic compositions, and the like); thermoplastic and/or thermoset polymers optionally reinforced with materials such as fiberglass mat or cloth, fibers, etc.; ceramic materials; cementitious materials; biomaterials; other composites; combinations of these; and the like.

Those skilled in the art will appreciate that composite 10 may, if desired, include additional layers (not shown). Such additional layer(s), for instance, may be interposed between gel coat layer 12 and the substrate 14. Additional layer(s) may also be provided on surface 20 of substrate 14. The substrate 14 itself also may be formed from multiple layers. In other embodiments, multiple gel coat layers could be used such as if an additional gel coat layer were to be provided on surface 20.

The gel coat layer 12 may be provided on substrate 14 in a variety of ways. According to one approach, the gel coat layer 12 or a precursor thereof is first formed against a mold surface, often referred to in the industry as a female mold when the gel coat layer 12 is intended to be an outside surface of the resultant structure 10. The layer or layers of the gel coat composition may each for example have a wet thickness of about 0.05 to about 0.8 mm. The substrate and/or other desired layers or structures (if any) may then be built up upon the gel coat material. The gel coat material used to from gel coat layer 12 may be uncured, partially cured, or at least substantially completely cured when these other features are created.

According to another approach, the substrate 14 pre-exists and an uncured gel coat composition is coated onto the substrate 14 in one or more layers and then cured to form the gel coat layer 12. The gel coat composition can be applied to the substrate 14 in any desired fashion including spraying, brushing, dipping, rolling, curtain coating, spin coating, combinations of these, and the like.

The following examples are offered to aid in understanding the present invention and are not to be construed as limiting the scope thereof. Unless otherwise indicated, all parts and percentages are by weight.

### EXAMPLE 1

2.86 moles of butyl ethyl propane diol (BEPD) and 5.72 moles of maleic anhydride were charged to a 3 liter flask equipped with an agitator, dean stark trap, condenser, thermometer and an inert gas inlet. The reactor was flushed with inert gas and heated to 80° C. allowing for an exotherm with a maximum of 105° C. The reaction was held at 102° C. until an acid number of 300 was achieved. 5.67 moles of Cardura E-10 monomer were then added slowly to the flask over a period of 30 minutes. The temperature of the reaction was raised to 120° C. and held there until an acid number of less than 3 was achieved. 4.56 moles of a c8 to c10 fatty acid and 70 grams of xylene were then added slowly to the flask over a period of 15 minutes. The temperature of the reaction was then raised to 220° C. while recovering water until an acid number of less than 3 was achieved. The reaction mixture was held at 220° C. for an additional hour while xylene was stripped from the reaction mixture. The final acid number of the reaction product was less than 3, the Mn was calculated to be 1,050, and the viscosity was GH=Z2 at % NVM=100 theoretical. Molecular weight as determined by GPC was Mn=1225, Mw=1785, and Mw/Mn=1.46.

The resulting resin was then further reduced in viscosity by adding Cardura E acrylate oligomer. The maximum ratio was 43% unsaturated polyester to 57% Cardura E acrylate. The viscosity of this blend was GH-0 at % NVM=100.

### EXAMPLE 2

4.56 moles of C8-C10 fatty acid and 5.67 moles of Cardura E-10 monomer were charged to a 3.0 liter flask equipped with an agitator, dean stark trap, condenser, thermometer, and inert gas inlet. The reactor was flushed with inert gas and heated to 116° C. allowing for an exotherm with a maximum of 150° C. The reaction was held at 150° C. until an acid number of less than 3.0 was achieved. 2.86 moles of butyl ethyl propane diol (BEPD), 5.73 moles of Maleic anhydride, and 90 grams xylene were then added slowly to the flask over a period of 15 minutes. The temperature of the reaction was then raised to 220° C. while recovering water until an acid number of less than 3.0 was achieved. The reaction mixture was held at 220° C. for an additional hour while xylene was stripped from the reaction mixture. The final acid number of the reaction product was less than 3, the viscosity was GH=Z2 at % NVM=100 (theoretical). Molecular weight as determined by GPC was: Mn=1230, Mw=1730, and Mw/Mn=1.41.

### EXAMPLE 3

2.86 moles of butyl ethyl propane diol (BEPD), 5.73 moles of maleic anhydride, 5.67 moles of Cardura E-10 monomer, 4.56 moles of C8-10 fatty acid, and 90 grams of xylene were charged to a 3 liter flask equipped with an agitator, dean stark trap, condenser, thermometer, and inert gas inlet. The flask was flushed with inert gas and heated to 220° C. The reaction temperature was held at 220° C. until and acid number of less than 3.0 was achieved. The reaction mixture was held at 220° C. for an additional hour while stripping xylene from the reaction mixture. The final acid number of the reaction product was less than 3, the viscosity was GH=Z2+ at % NVM=100 (theoretical). Molecular weight as determined by GPC was: Mn=1350, Mw=2070, and Mw/Mn=1.54.

### EXAMPLE 4

Illustrative embodiments of curable colorant components would be prepared from the following ingredients (all materials supplied as 100% solids unless otherwise expressly noted):

| | Parts by weight | | | |
|---|---|---|---|---|
| | Sample | Sample | Sample | Sample |
| Ingredient | 1 | 2 | 3 | 4 |
| Curable polyester resin prepared in | 85 | | | 85 |
| Example 1 | | | | |
| Curable polyester resin prepared in | | 85 | | |
| Example 2 | | | | |
| Curable polyester resin prepared in | | | 85 | |
| Example 3 | | | | |
| Pigment(s) | 14.5 | 14.5 | 14.5 | 14.5 |
| BYK330 (supplied by BYK Chemie) Flow | 0.5 | 0.5 | 0.5 | 1.0 |
| and Levelling agent | | | | |
| BYK P104S (supplied by BYK Chemie) | 0.5 | 0.5 | 0.5 | 0.5 |
| Pigment wetting agent | | | | |
| Ortho-methylhydroquinone (THQ) | 0.5 | 0.5 | 0.5 | 0.5 |
| inhibitor | | | | |

For each Sample, the curable polyester resin and the pigment would be combined and thoroughly mixed in a high speed mixer. After this first charge is thoroughly mixed, a second charge including the remaining ingredients is added to the high speed mixer. The mixture is mixed to a hegman grind of 1.

The mixture then would be transferred to a basket mill including glass beads as milling media and milled to a hegman grind of 7. The resultant pigment dispersion would be evaluated by quality control to confirm that the material meets desired specifications such as with respect to strength, color, and viscosity. If the specifications are satisfied, the pigment dispersion would be filtered through a 300 micrometer metal mesh filter and then stored in a suitable vessel that is isolated from the ambient. A liner in the storage vessel would be used to help isolate the material from a headspace, if any, in the vessel.

### EXAMPLE 5

Illustrative embodiments of curable gel coat compositions of the invention are obtained by combining ingredients as follows (all ingredients are supplied as 100% solids unless otherwise expressly noted:

| | Parts by Weight | | | | | |
|---|---|---|---|---|---|---|
| | Sample | Sample | Sample | Sample | Sample | Sample |
| Ingredient | 5 | 6 | 7 | 8 | 9 | 10 |
| Pigment Dispersion of | 1 | 2 | 7 | 11 | 15 | 20 |
| Sample 1 | | | | | | |
| Isopthalic/neopentyl | 32 | 40 | 40 | 32 | 40 | 45 |
| glycol polyester resin | | | | | | |
| [Mw = 2971, Mn = 1448 | | | | | | |
| Mw/Mn = 2.06] | | | | | | |
| Orthophthalic/neopentyl | 8 | 10 | 10 | 8 | 10 | 5 |
| glycol polyester resin | | | | | | |
| [Mw = 3240, Mn = 1433 | | | | | | |
| Mw/Mn = 2.26] | | | | | | |
| Microtalc (MT1250 | 7 | 14 | 20 | 10 | 0 | 0 |
| grade) | | | | | | |
| Aluminum trihydrate | 3 | 6 | 0 | 0 | 20 | 10 |
| Thickening agent (Aerosil | 1 | 3 | 2 | 3 | 2 | 1 |
| 200 available from | | | | | | |
| Evonik Degussa) | | | | | | |
| Inhibitor (THQ) | 0.3 | 0.3 | 0.3 | 0.3 | 0.3 | 0.3 |
| Promoter (Cobalt 12% | 0.25 | 0.25 | 0.25 | 0.25 | 0.25 | 0.25 |
| Cem-All ® available as | | | | | | |
| 12% cobalt solids in a | | | | | | |
| carrier from OM Group, | | | | | | |
| Inc., Cleveland, Ohio) | | | | | | |
| Promoter (21% Cobalt | 0.25 | 0.25 | 0.25 | 0.25 | 0.25 | 0.25 |
| Hydroxy Ten Cem ® | | | | | | |
| available as 21% solids in | | | | | | |
| a carrier from OM Group, | | | | | | |
| Inc., Cleveland, Ohio) | | | | | | |
| Promoter (Potassium Hex | 0.2 | 0.2 | 0.2 | 0.2 | 0.2 | 0.2 |
| Cem ® available as 15% | | | | | | |
| solids in a carrier from | | | | | | |
| OM Group, Inc., | | | | | | |
| Cleveland, Ohio) | | | | | | |
| Anti-fisheye agent | 0.25 | 0.25 | 0.25 | 0.25 | 0.25 | 0.25 |
| (DC200 available from | | | | | | |
| Dow Chemical Co.) | | | | | | |
| Antifoaming agent (BYK- | 0.5 | | | | | 1.1 |
| A555 available from BYK | | | | | | |
| Chemie) | | | | | | |
| Pigment Wetting agent | | 0.5 | | | | |
| (BYK 1045 available | | | | | | |
| from BYK Chemie) | | | | | | |
| Antifoaming agent | | | 1.5 | | | |
| (Tinuvin 123 available | | | | | | |
| from Ciba) | | | | | | |
| Antifoaming agent | | | | 0.9 | | |
| (Tinuvin 328 available | | | | | | |
| from Ciba) | | | | | | |
| Antifoaming agent | | | | | 1.2 | |
| (Antifoam A available | | | | | | |
| from DOW CORNING) | | | | | | |

For each Sample, the pigment dispersion, the isophtalic/neopentyl glycol (ISO/NPG) polyester resin, and the orthphtalic neopentyl glycol (ORTHO/NPG) polyester resin are combined and thoroughly blended in a high speed mixer. In accordance with the specific recipes illustrated in the table above, the curable gel coat composition desirably includes from about 1 to about 20 parts by weight of the pigment dispersion per about 40 to about 50 parts by weight of the ISO/NPG and ORTHO/NPG polyester resins. The amount of pigment dispersion may depend upon the color that is being mixed. Bright colors such as yellows and oranges desirably include relatively greater amounts of the pigment dispersion, e.g., from about 15 to about 20 parts by weight per about 40 to about 50 parts by weight of the ISO/NPG and ORTHO/NPG polyester resins. Darker colors such as black desirably include relatively lesser amounts of the pigment dispersion, e.g., from about 2 to about 4 parts by weight per about 40 to about 50 parts by weight of the ISO/NPG and ORTHO/NPG polyester resins. Light colors such as off white desirably include even lesser amounts of pigment dispersion, e.g., about 1 part by weight per about 40 to about 50 parts by weight of the ISO/NPG and ORTHO/NPG polyester resins.

The weight ratio of the ISO/NPG and ORTHO/NPG polyester resins can vary over a wide range such as from 1:10 to 10:1. As exemplified in these recipes, the ratio is 80:20.

Next, the extender fillers such as the microtalc and/or the aluminum trihydrate are added to the high speed mixer and mixed thoroughly into the mixture. As exemplified by these recipes, the mixture desirably would incorporate from about 10 to about 20 parts by weight of the extender filler(s) per about 1 to about 20 parts by weight of the pigment dispersion.

The remaining ingredients would then be added to the high speed mixer. The material would be mixed to a hegman grind of about 6 to 7. As exemplified, using from about 1 to about 3 parts by weight of the thickening agent per about 1 to about 20 parts by weight of the pigment dispersion would be suitable. Suitable amounts of the other additives are used to achieve the desired effect. Exemplary amounts of these are illustrated in the table.

After mixing to a hegman grind of about 6 to about 7, the mixture desirably assessed for quality control to see if specifications for strength, color, viscosity, cure time, and solids level are satisfied. If the specifications are satisfied, the resultant curable gel coat composition would be filtered through a 300 micrometer metal mesh filter and then stored in a suitable vessel that is isolated from the ambient. A liner in the storage vessel would be used to help isolate the material from a headspace, if any, in the vessel.

### EXAMPLE 6

Samples 11-16 are prepared using the procedure of Example 5 except that Sample 2 is used in place of Sample 1.

### EXAMPLE 7

Samples 17-22 are prepared using the procedure of Example 5 except that Sample 3 is used in place of Sample 1.

### EXAMPLE 8

Samples 23-28 are prepared using the procedure of Example 5 except that Sample 4 is used in place of Sample 1.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

What is claimed is:

1. A system for providing a colored, curable coating composition on demand, comprising:
a) a plurality of color components each providing a color characteristic, each color component comprising a curable resin, wherein the curable resin of at least one of the color components comprises a curable polyester resin having a polydispersity of less than about 3: and
b) a recipe for combining ingredients including at least one of the color components to provide a curable coating composition having a desired color characteristic.

2. The system of claim 1, wherein the color components comprise a first color component comprising a curable resin, and a second color component comprising the polyester resin having a polydispersity of less than about 3.

3. The system of claim 1 wherein each color component comprises the polyester resin having a polydispersity of less than about 3.

4. A colored component of a gel coat composition comprising:
a) a colorant component comprising a colorant and a curable polyester resin carrier, the curable polyester resin carrier having a polydispersity of less than about 3; and
b) a gel coat resin component comprising a curable resin.

5. The colorant component of claim 4, wherein the curable polyester resin carrier comprises from about 55 to about 95 weight percent of the colorant component.

6. The colorant component of claim 4, wherein the colorant comprises from about 5 to about 45 weight percent of the colorant component.

7. The colorant component of claim 4, wherein at least a portion of the curable polyester resin carrier comprises one or more structural features that protect the ester linkages from hydrolytic degradation.

8. The colorant component of claim 7, wherein the structural features comprise hydrophobic moieties pendant from the polyester backbone in close proximity to the ester linkages.

9. The colorant composition of claim 8, wherein the hydrophobic moieties are no farther than about 10 backbone from the ether linkage.

10. The colorant composition of claim 7, wherein the structural features are nonpolar.

11. The colorant composition of claim 10, wherein the structural feature is selected from the group consisting of linear, straight, cyclic, fused, and/or branched hydrocarbyl moieties that may be alkyl, aryl, and/or alkaryl.

12. The colorant composition of claim 11, wherein the structural feature has the structure
—C(O)OCH₂C(R¹)(R²)CH₂O(O)C—
wherein each of R¹ and R² is independently a protecting group pendant from the backbone carbon atom this is in the beta position relative to first and second ester linkages, and wherein R¹ is ethyl and R² is butyl, isobutyl, or sec-butyl.

13. A method of making a colored curable coating composition on demand, comprising the steps of:
a) providing a system according to claim 1; and
b) using the recipe to blend at least one of the color components with ingredients comprising at least one other system component to provide the colored, curable, coating composition.

14. A composite panel comprising a coating on a substrate, said coating being derived from a curable coating composition comprising a colorant and a curable polyester resin having a polydispersity of less than about 3.
